(19) United States
(12) Patent Application Publication
(10) Pub. No.: US 2013/0311416 A1
(43) Pub. Date: Nov. 21, 2013

(54) RECOMMENDING TRAINING PROGRAMS

(71) Applicants: Hua Liu, Fairport, NY (US); Robert J. St. Jacques, JR., Fairport, NY (US)

(72) Inventors: Hua Liu, Fairport, NY (US); Robert J. St. Jacques, JR., Fairport, NY (US)

(73) Assignee: XEROX CORPORATION, Norwalk, CT (US)

(21) Appl. No.: 13/472,529

(22) Filed: May 16, 2012

(51) Int. Cl. G06N 5/02

(52) U.S. Cl. 706/46

(57) ABSTRACT

A method, a system, and a computer program product for recommending one or more training programs to a user. The method includes determining a first set of skills associated with a user profile. One or more jobs are identified based on the user profile and the first set of skills. Thereafter, a second set of skills associated with the one or more jobs is determined. Subsequently, a third set of skills representing a gap between the first set of skills and the second set of skills is determined. Based on the third set of skills the one or more training programs are recommended to the user.

### TECHNICAL FIELD

The presently disclosed embodiments are directed to identification of a skill gap. More particularly, the presently disclosed embodiments are directed to a technique for recommending training programs to a user based on the skill gap.

### BACKGROUND

Presently, a user has to manually search for job postings that interest him. For example, the user searches for a job at a dream company and would have skills to potentially get the job. The user may search for the jobs on various online job portals or company's website. Once the user finds the jobs that he is interested in, he may identify various skills that he lacks. The user may then attend training programs (e.g., at a local college or institution) to fill those skill gaps to improve his candidature for the jobs. In certain scenarios, such a process can be time-consuming and prone to errors. Furthermore, because of the manual nature of the process, users who are not vigilant may miss opportunities.

### SUMMARY

According to embodiments illustrated herein, there is provided a method for recommending one or more training programs to a user. The method includes determining a first set of skills associated with a user profile. One or more jobs are determined based on the user profile and the first set of skills. A second set of skills associated with the one or more jobs is then determined. Thereafter, a third set of skills representing a gap between the first set of skills and the second set of skills is determined, where the third set of skills is not present in the first set of skills. Based on the third set of skills, the one or more training programs are recommended to the user.

According to embodiments illustrated herein, there is provided a system for recommending one or more training programs to a user. The system includes a skill extraction module, a comparison module, and a training query engine. The skill extraction module is configured for determining a first set of skills associated with a user profile. The skill extraction module is also configured for determining a second set of skills associated with one or more jobs. The one or more jobs are determined based at least in part on the first set of skills. The comparison module determines a third set of skills representing a gap between the first set of skills and the second set of skills, where the third set of skills is not present in the first set of skills. Based on the third set of skills, the training query engine identifies the one or more training programs.

According to embodiments illustrated herein, there is provided computer program product for use with a computer. The computer program product comprises a computer-usable data carrier storing a computer readable program code embodied therein for recommending one or more training programs to a user. The computer readable program code includes program instruction means for determining a gap between a first set of skills and a second set of skills. The first set of skills is determinable from a user profile. The second set of skills is determinable from one or more jobs identified based on the user profile and the first set of skills. The gap represents a third set of skills present in the second set of skills but not present in the first set of skills. Further, the computer readable program code includes program instruction means for identifying the one or more training programs based on the third set of skills.

### BRIEF DESCRIPTION OF DRAWINGS

The accompanying drawings, which are incorporated in, illustrate various example systems, methods, and other embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

Various embodiments will hereinafter be described in accordance with the appended drawings provided to illustrate and not to limit the scope in any manner, wherein like designations denote similar elements, and in which:

FIG. 1 is a block diagram illustrating an environment in which various embodiments can be implemented;

FIG. 2 is a block diagram illustrating a recommendation system in accordance with at least one embodiment; and

FIG. 3 is a flow diagram illustrating a method for recommending one or more training programs in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed description given herein with respect to the figures is just for explanatory purposes as the method and the system extend beyond the described embodiments. For example, those skilled in the art will appreciate that, in light of the teachings presented, multiple alternate and suitable approaches can be realized, depending on the needs of a particular application, to implement the functionality of any detail described herein, beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but not every embodiment or example necessarily includes that particular feature, structure, characteristic, property, element, or limitation. Furthermore, repeated use of the phrase “in an embodiment” does not necessarily refer to the same embodiment, although it may.

Definition of Terms: Terms not specifically defined herein should be given the meanings that would be given to them by one of skill in the art in light of the disclosure and the context. As used in the present specification and claims, however, unless specified to the contrary, the following terms have the meaning indicated.

User Profile: The user profile includes personal information (e.g., family details, contact details like phone number and email-ID, personal achievements, and the like), one or more skills, educational details, and employment history of the user. In an embodiment, the user profile also includes a first set of preferences. The first set of preferences includes one or more preferred job locations, hobbies, or one or more desired employers of the user. In an embodiment, the first set of preferences also includes a job search history of the user. While creating the user profile, the one or more skills can be selected by the user from a predefined list. The user may have described his skills in unstructured text as part of the user profile.

Jobs: In an embodiment, the jobs include one or more projects (or tasks) that an organization (e.g., various employers) is involved in. Various job listings containing information on one or more jobs are posted on the organization's server (e.g., organization's internal job portals) or any other external job portals (e.g., job listing websites like, www.monster.com, www.careerbuilder.com, www.usajobs.gov, www.job.com, www.indeed.com, and so forth). Each job (e.g., the associated job listing) may have associated text describing various requirements, such as, required educational qualifications, required skills, job responsibilities, location details, salary details, and so forth. The jobs may be posted by various employers (e.g., companies or individuals).

Skill: A skill is a learned capacity to carry out various tasks/jobs. In the domain of work, skills can be general (e.g., time management, teamwork, leadership, etc.) or domain specific (e.g., HTML, XML, WSDL, SOAP, JAVA, etc.). While creating the user profile, the one or more skills can be selected by the user from a predefined list. The user may have described his skills in unstructured text as part of the user profile. Further, while posting the job listings, various employers may define (or include) desirable skills in accordance with the associated key responsibility area (KRA) from a predefined list of skills. In an embodiment, the employers may describe the required skills for a job in the form of unstructured, long job description (e.g., as a part of a text written for the educational qualifications, job responsibilities, or any other section).

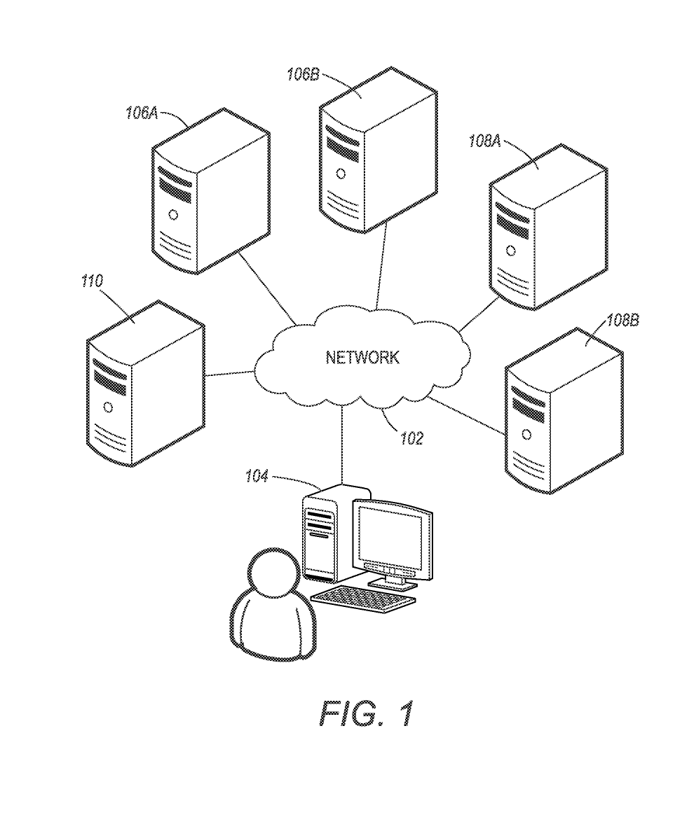

FIG. 1 is a block diagram illustrating an environment 100 in which various embodiments can be implemented. Environment 100 includes a network 102, a computing system 104, job servers 106a and 106b (hereinafter referred to as job servers 106), training servers 108a and 108b (hereinafter referred to as training servers 108), and a recommendation server 110.

The network 102 interconnects the computing system 104, the job servers 106, the training servers 108, and the recommendation server 110. The network 102 is a medium through which various queries, and content flow among the computing system 104, the job servers 106, the training servers 108, and the recommendation server 110. Examples of the network 102 may include, but are not limited to, LAN, WLAN, MAN, WAN, and the Internet. Communication over the network 102 may be performed in accordance with various communication protocols such as Transmission Control Protocol and Internet Protocol (TCP/IP), User Datagram Protocol (UDP) and IEEE 802.11n communication protocols.

A user operates the computing system 104. A desktop computer is shown to represent computing system 104, however, various examples of the computing system 104 include, but are not limited to, a Personal Digital Assistant (PDA), a smart phone, a laptop computer, a notebook computer, a notepad computer, and the like.

The job servers 106 represent servers hosting various jobs listing websites (e.g., www.monster.com, www.careerbuilder.com, www.usajobs.gov, www.job.com, www.indeed.com, and so forth). The job servers 106 host various job listings. The job servers 106 may further include a database of user profiles associated with users seeking jobs.

The training servers 108 represent servers that host websites of various training provider organizations (e.g., E-learning institutes, Instructors Network, Inc., Interview Helper, Education Services Australia, and so forth). The training servers 108 host various training programs including associated schedule and description of topics covered in each training program.

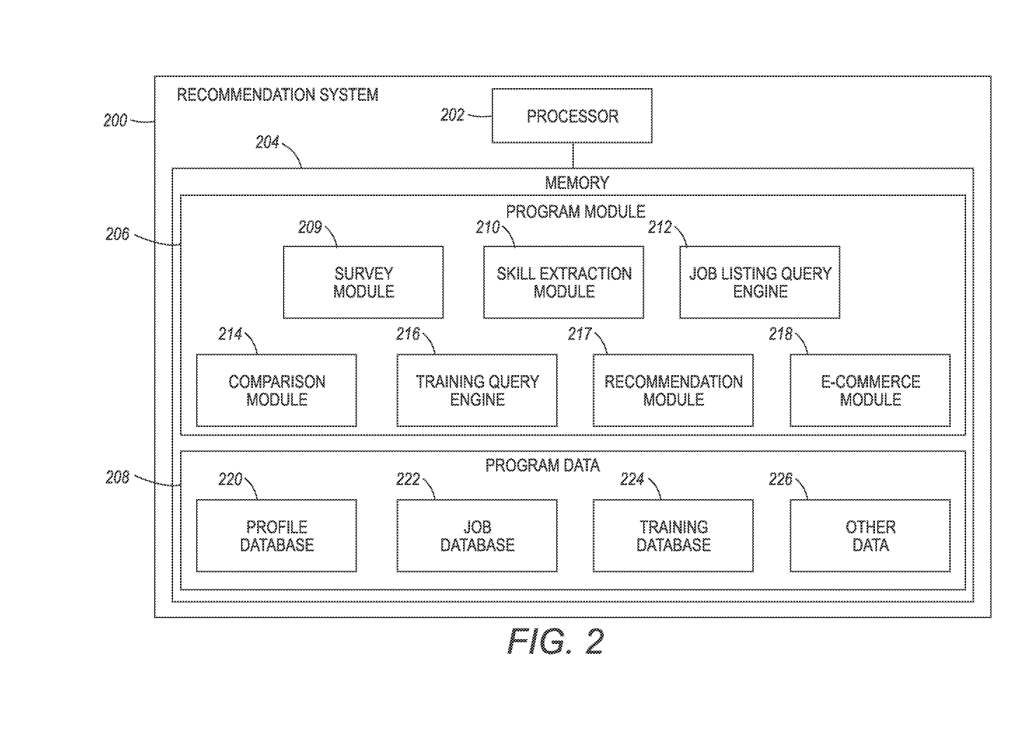

In an embodiment, the recommendation server 110 hosts a recommendation system (e.g., a recommendation system 200 as explained in FIG. 2) for recommending one or more training programs to a user. However, the recommendation system can be hosted at other servers including, but not limited to, the job servers 106 or the training servers 108 without departing from the scope of the ongoing description. In another embodiment, recommendation server 110 includes a database of user profiles. For example, recommendation server 110 hosts a third party website (a social or a professional networking website) that stores profiles of registered users. In an embodiment, the recommendation system may provide the functionality of (e.g., a service on the third party website or any other website for) recommending one or more training programs to the registered users.

In an embodiment, the user that operates the computing system 104 accesses the third party website. Further, the user has created his user profile on the third party website. In an embodiment, the user registers for availing the service. The user then submits a request (e.g., by mouse clicks or keyboard inputs) on the website to recommend him various training programs for various jobs that suit him.

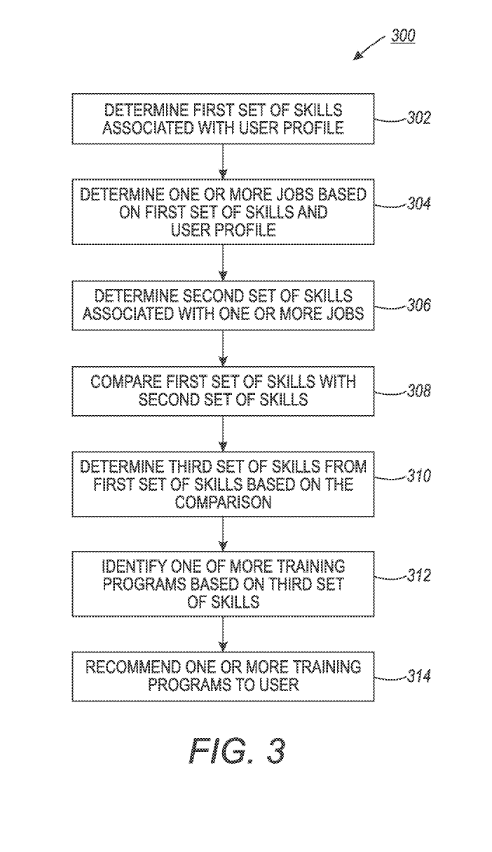

The recommendation system then recommends one or more training programs to the user based on the user profile and one or more jobs relevant to the user. This is further explained in detail in conjunction with FIG. 2 and FIG. 3.

FIG. 2 is a block diagram illustrating the recommendation system 200 in accordance with at least one embodiment. The recommendation system 200 includes a processor 202 and a memory 204. The memory 204 includes a program module 206 and a program data 208. The program module 206 includes a survey module 209, a skill extraction module 210, a job listing query engine 212, a comparison module 214, a training query engine 216, a recommendation module 217, and an E-commerce module 218. The program data 208 includes a profile database 220, a job database 222, training database 224, and other data 226.

In an embodiment, the profile database 220 stores user profiles of multiple users (e.g. the users having their user profiles on the third party website or users who are registered to avail the service). As disclosed earlier, the job servers 106 may also maintain the database of user profiles (e.g., user profiles of job seekers).

In an embodiment, the job database 222 stores multiple job listings. For example, if the service of recommending the training programs to be provided at the third party website, the job database 222 represents the multiple jobs listings posted on the third party website. As disclosed earlier, each job servers 106 also hosts various job listings.

When the user submits the request for recommendation of a training program, the survey module 209 presents the user a brief survey, asking the user a questionnaire to collect a second set of preferences. The questionnaire in the survey include topics such as the user's availability for training (e.g., “Nights/Weekends”), user's desired companies (of which the user can choose several from the predefined list including, e.g., Google®, Xerox®, Apple®, IBM®, etc.), the user's preferred job locations, and how often (e.g., frequency at which) the user would like the recommendation system 200 to automatically generate a recommendation report. The collected second set of preferences will be considered by the job listing query engine 212 to identify relevant jobs for the user. The collected second set of preferences will also be considered by the training query engine 216 to identify relevant training programs for the user.

The skill extraction module 210 determines a first set of skills from the user profile. In an embodiment, if the user is registered on the third party website, the skill extraction module 210 accesses the corresponding user profile from the third party website. In another embodiment, the skill extraction module 210 accesses the user profile from the profile database 220. The skill extraction module 210 also determines a second set of skills from one or more jobs (e.g., from job listings associated with the one or more jobs). In order to extract the first set of skills and the second set of skills, the skill extraction module 210 implements a text processing technique.

If the user profile (or the job listings associated with the one or more jobs) includes skills selected from the predefined list of skills, then the skills, included in the user profile (or the job listings associated with the one or more jobs) are identified by the skill extraction module 210.

If the user profile (or the job listings associated with the one or more jobs) includes skills in the unstructured format, the skill extraction module 210 parses the text in the user profile (or the job listings associated with the one or more jobs). Various less important words (e.g., and, to, for, the, and the like) are eliminated by skill extraction module 210 from the parsed text. Various skills are then identified by comparing different words (e.g., java, html, etc.) and short phrases (e.g., web developer, C programmer, etc.) in the parsed text to a set of pre-determined skills. In an embodiment, the set of pre-determined skills are stored in the other data 226. In an embodiment, more recent skills (e.g., listed as part of job experience in the user profile from the last five years) are prioritized over older skills in the identified skills.

In an embodiment, users (or employers posting the job listings) may use different words to describe the same skill set (e.g., HTML, XML, WSDL, and SOAP are all terms that would imply a familiarity with SGML). In order to extract such relations among the skills, the skill extraction module 210 maintains a skill dictionary as a part of the other data 226, so that common synonyms can be translated and mapped onto a desired skill hierarchy. In an embodiment, the skill dictionary includes synonym tables to obtain the skill hierarchy. This mapping may then used later when matching an individual's skills (e.g., the first set of skills) against the desired skills (e.g., the second set of skills) for lucrative job postings. The skill extraction module 210 constantly maintains the skill dictionary to add new skills and prune outdated skills.

In an embodiment, the skill extraction module 210 constructs the skill hierarchy from a sentence structure. For example, such a description (e.g., in the user profile or a job listing) “has cloud computing knowledge such as virtualization and resource provisioning” suggests that “virtualization” and “resource provisioning” are detailed skills of cloud computing.

In an embodiment, the skill extraction module 210 constructs the skill hierarchy based on an appearance frequency of various terms (e.g., words or phrases). Based on heuristics, higher-level skill terms appear more than lower-level skill terms. A common practice in describing one's skills and knowledge is to highlight a specialized area, followed by detailed description of expertise.

The skill extraction module 210 constructs the skill hierarchy by implementing various linguistic programming (or human programming) toolkits. Further, the approaches listed above for constructing the skill hierarchy are examples and any other suitable approach can also be applied to construct the skill hierarchy. Various examples of the linguistic programming toolkits include the Stanford Parser (implemented in Java) and Natural Language Toolkit (NLTK) (implemented in Python).

The skill extraction module 210 refers the skill hierarchy to infer some skills from others deeper skills in the skill hierarchy. For example, if an individual chooses ‘WSDL’ and ‘SOAP’ as skills, then the ‘XML’ and ‘SGML’ skills may also be inferred by the skill extraction module 210.

Based on the technique disclosed above, the skill extraction module 210 determines the first set of skills (hereinafter referred to as S1) from the user profile.

S1={A,B,C,D} Equation-1

where, A, B, C, D represents various skills (e.g., XML, SGML, SOAP, WSDL, and the like) determined from the user profile.

The skill extraction module 210 stores the first set of skills in the other data 226.

Similarly, the skill extraction module 210 determines the second set of skills (hereinafter referred to as S2) from the one or more jobs. Further, the determination of the one or more jobs is described in the description below.

S2={A,B,X,Y} Equation-2

where, X and Y represents various skills (e.g., network management, JAVA, and the like) determined from the one or more jobs.

The skill extraction module 210 stores the second set of skills in the other data 226.

The job listing query engine 212 formulates one or more job queries based on the first set of skills and other information, such as, the first set of preferences and the second set of preferences. In an embodiment, the job listing query engine 212 then submits the one or more job queries to job servers 106. In another embodiment, the job listing query engine 212 searches various jobs (e.g., job listings) from the job database 222 that satisfies the one or more job queries. Based on the one or more job queries, the job listing query engine 212 obtains a list of jobs from at least one of the job servers 106 or the job database 222. The job listing query engine 212 then determines the one or more jobs after removing duplicate jobs from the list of jobs. The job listing query engine 212 then provides the one or more jobs to the skill extraction module 210. The job listing query engine 212 then stores the identified one or more jobs (e.g., the job listings associated with the one or more jobs) in other data 226.

Comparison module 214 identifies a third set of skills representing a skill gap by comparing the first set of skills and the second set of skills. The third set of skills represents the skills that are required for satisfying the requirements of the one or more jobs, however, not possessed by the user. This is further explained in detail in conjunction with FIG. 3. The comparison module 214 then provides the third set of skills to the training query engine 216.

The training query engine 216 identifies one or more training programs from the training database and the training servers 108, based on the third set of skills and at least one of the first set of preferences and the second set of preferences. This is further explained in the description infra. The training query engine 216 then stores the third set of skills and the information on the identified one or more training programs in the other data 226.

The recommendation module 217 obtains the third set of skills and the information on the identified one or more training programs from the other data 226. The recommendation module 217 then creates the recommendation report for the user based on the third set of skills and the one or more training programs. In an embodiment, the recommendation report includes details on a training program associated with one or more of the skills in the third set of skills. For example, the details on the training program include, but are not limited to, a link to a webpage associated with the training program, a schedule of the training program, associated venue, information on trainers, fees, and so forth. In an embodiment, the recommendation report is displayed on the computing system 104 from which the user has submitted the request for recommendation. In another embodiment, recommendation module 217 sends an email to a registered email address of the user. In yet another embodiment, recommendation module 217 sends a text message (e.g., an SMS) to the user's registered mobile number. In an embodiment, the recommendation report is issued to the user at the frequency desired by the user (e.g., based on the frequency information provided by the user while filling the survey).

In an embodiment, the recommendation report is dynamically customizable based on user inputs. The details on the one or more training programs or the one or more jobs listed in the recommendation report are sorted (e.g., based on the fees, the schedule, vicinity to the user's location/address, and so forth) according to the user inputs received when the user is viewing the recommendation report. This can be implemented by storing the recommendation results (e.g., the one or more jobs and the one or more jobs listed in the recommendation report) at the other data 226. The recommendation module 217 then filters recommendation results that do not match the user inputs. Thereafter, the recommendation module 217 performs sorting operation to place the remaining recommendation results in the order that the user specifies.

In an embodiment, if the user does not like the recommendation results (e.g., the one or more jobs and the one or more training programs listed) in the recommendation report, the recommendation system 200 facilitates the user to input feedback on the recommendation report. In an embodiment, an option is provided in the recommendation report for enabling the user to provide the feedback on the one or more jobs and the one or more training programs listed in the recommendation report. In an embodiment, the skill extraction module 210 and the recommendation module 217 receives the user feedback. In an embodiment, the skill hierarchy and the skill dictionary are updated based on the user feedback so as to fetch more relevant jobs and hence more relevant training programs.

The e-commerce module 218 generates and maintains billing information based on at least one of the one or more jobs or the one or more training programs. The billing information will then be used by the recommendation system 200 to bill the user, the job servers 106, and the training servers 108. In an embodiment, the e-commerce module 218 generates billing report on the basis of the billing information. The e-commerce module 218 then issues the billing report to the user, the job servers 106, and the training servers 108 at predefined time periods (e.g. weekly, monthly).

In an embodiment, the service of recommendation of training program is provided to the user for free (e.g., without any cost) for a predefined period of time. So, the e-commerce module 218 will not generate any billing information for the predefined period of time.

FIG. 3 is a flow diagram 300 illustrating a method for recommending one or more training programs in accordance with at least one embodiment.

At step 302, the first set of skills associated with the user profile is determined. As discussed earlier, in order to extract the first set of skills, the skill extraction module 210 of the recommendation system 200 accesses the user profile from profile database 220 or the one or more job servers 106. The first set of skills is extracted by implementing various text processing techniques discussed in FIG. 2.

At step 304, the one or more jobs are determined based on the first set of skills and the user profile. As described earlier, the one or more job queries are submitted to the job servers 106 and job database 222 by the job listing query engine 212. Based on the one or more job queries, the list of jobs from at least one of the job servers 106 or the job database 222 is obtained by the job listing query engine 212. Various duplicate job listings from the list of jobs are then removed by the job listing query engine 212 to determine the one or more jobs.

At step 306, the second set of skills associated with the one or more jobs are determined. The second set of skills is by the skill extraction module 210. In order to identify the second set of skills from various job postings, the text processing technique is applied by the skill extraction module 210.

At step 308, the first set of the skills (S1) is compared with the second set of skills (S2). In an embodiment, the set S1 is subtracted from the set S2.

At step 310, the third set of skills (hereinafter referred to as S3) is determined based on the comparison. The third set of skills (S3) represents a difference (e.g., a skill gap) between the set S1 and the set S2. The set S3 includes the skills that are required for the one or more jobs, however, are not present in the set S1 (e.g., the skills possessed by the user).

S3=S2−S1={X,Y} Equation-3

At step 312, the one or more training programs are identified based on the third set of skills. Once the third set of skills (S3) is identified, the one or more training programs are identified by the training query engine 216. One or more training queries are generated by the training query engine 216. In an embodiment, the one or more preference from at least one of the first set preferences and the second set of preferences are also considered by the training query engine 216 to generate the one or more training queries. The one or more training queries are then submitted to training servers 108. In an embodiment, the training database 224 is also searched using the one or more training queries by the training query engine 216 for identifying any relevant training programs. Based on the one or more training queries, the training query engine 216 obtains a list of training programs from at least one of the training servers 108 or the training database 224. For example, the list of training programs includes a training program that is suitable to the availability of the user. Similarly, the identified one or more training programs satisfies the one or more preferences.

In an embodiment, if the third set of skills is a null set (i.e., the first set of skills and the second set of skills are same) then search for training programs will not be performed by the training query engine 216 and hence no training programs are identified. The recommendation module 217 is instructed by the training query engine 216 to generate a predefined recommendation report indicating that the user's skills matches with the various skills required for the one or more jobs and no training is required.

At step 314, the identified one or more training programs are recommended to the user. As discussed in the description supra, the recommendation report is generated by the recommendation module 217 and communicated to the user.

In an embodiment, the computing system 104 is associated with an organization (e.g., current employer of the user). The recommendation server 110 represents the organization's server. In this case, the recommendation system enables the user (i.e., an employee of the organization) to identify various internal training programs that he should undergo to become suitable candidate for various internal projects (e.g., jobs).

In an embodiment, the user that operates the computing system 104 accesses the organization's internal portal (i.e., that facilitates the service of recommending training programs.). The user profile of the user may be created by the user or by another individual (e.g., a Human Resource executive in the organization) on behalf of the user. In an embodiment, the user registers for availing the service. The profile database 220 stores user profiles of associated users (e.g., employees of the organization). Further, the training database 224 stores information on various internal training programs provided by the organization to its employees.

The user then submits a request (e.g., by mouse clicks or keyboard inputs) on the internal portal to recommend him various training programs for the internal projects that suit him. Based on the user profile and the internal projects that suit to the user the recommendation system 200 identifies one or more internal training programs suitable for the user.

In an embodiment, an access to the external job listing provider websites (e.g., websites hosted by job servers 106) may be prohibited by the organization due to various security reasons. In such a case, the job listing query engine 212 searches the jobs from the job database 222. This is a typical scenario where the recommendation system 200 is configured to help the employees find necessary training programs for various internal projects (e.g., various jobs in the organization) and restrict them from searching trainings suitable for external jobs (e.g., jobs from other employers).

The disclosed methods and systems, as described in the ongoing description or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive, etc. The storage device may also be other similar means for loading computer programs or other instructions into the computer system. The computer system also includes a communication unit. The communication unit allows the computer to connect to other databases and the Internet through an Input/Output (I/O) interface, allowing the transfer as well as reception of data from other databases. The communication unit may include a modem, an Ethernet card, or other similar devices, which enable the computer system to connect to databases and networks such as LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information as desired. The storage element may be in the form of an information source or a physical memory element present in the processing machine.

The programmable or computer-readable instructions may include various commands that instruct the processing machine to perform specific tasks, such as, the steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to ‘C’, ‘C++’, ‘Visual C++’ and ‘Visual Basic’. Further, the software may be in the form of a collection of separate programs, a program module with a larger program or a portion of a program module, as in the disclosure. The software may also include modular programming in the form of object-oriented programming. The processing of input data by the processing machine may be in response to user commands, results of previous processing or a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, with the product capable of implementing the above methods and systems, or the numerous possible variations thereof.

The method, system, and computer program product, as described above, have numerous advantages. Some of these advantages may include, but are not limited to, automatically recommending the one or more training programs to the user. The use of the recommendation service saves a lot of important time of the users that they otherwise would have ended up spending searching for jobs and then identifying various training programs. Also, in the scenario where the recommendation system 200 is implemented on the organization's network, it helps the associated employees identify various training programs before applying for any projects that suits them. Further, various preferences of the user are also considered for identifying the training programs. This ensures that the training programs that suit the preferences will be delivered to the user. Further, various job listing providers (e.g., Monster®, Career Builder®, etc.) get benefited as the recommendation system 200 searches jobs listing on their associated servers (e.g., job servers 106). Also, various training provider institutions (e.g., E-learning institutes, Instructors Network, Inc., Interview Helper, Education Services Australia, and so forth) are benefited as the recommendation system 200 searches various training programs from their associated servers (e.g., training servers 108) and as more users may register for availing training programs.

Various embodiments of the method and system for processing search queries have been disclosed. It should be apparent, however, to those skilled in the art that many more modifications besides those already described are possible without departing from the inventive concepts herein. The embodiments, therefore, are not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It will be appreciated by a person skilled in the art that the system, modules, and sub-modules have been illustrated and explained to serve as examples and should not be considered limiting in any manner. It will be appreciated that the variants of the above disclosed system elements, or modules and other features and functions, or alternatives thereof, may be combined to create many other different systems or applications.

Those skilled in the art will appreciate that any of the foregoing steps and/or system modules may be suitably replaced, reordered, or removed, and additional steps and/or system modules may be inserted, depending on the needs of a particular application, and that the systems of the foregoing embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer implemented method for recommending one or more training programs to a user, the method comprising:
determining a first set of skills associated with a user profile;
determining one or more jobs based on the user profile and the first set of skills;
determining a second set of skills associated with the one or more jobs;
determining a third set of skills representing a gap between the first set of skills and the second set of skills, wherein the third set of skills is not present in the first set of skills; and
recommending the one or more training programs to the user based on the third set of skills.

2. The computer implemented method of claim 1 wherein the user profile comprises at least one of personal information, one or more skills, educational details, employment history of the user.

3. The computer implemented method of claim 1, wherein the user profile further comprises a first set of preferences comprising at least one of one or more preferred locations, hobbies, or one or more desired employers of the user.

4. The computer implemented method of claim 3, wherein the one or more jobs and the one or more training programs are determined based at least in part on the first set of preferences.

5. The computer implemented method of claim 1 further comprising presenting a survey to the user to collect a second set of preferences, wherein the second set of preferences comprises at least one of the user's availability for training, one or more preferred locations, one or more desired employers of the user, and a frequency of receiving recommendations.

6. The computer implemented method 5, wherein the one or more jobs and the one or more training programs are determined based at least in part on the second set of preferences.

7. The computer implemented method of claim 1 further comprising comparing the first set of skills with the second set of skills to obtain the third set of skills.

8. The computer implemented method of claim 1 further comprising identifying the one or more training programs based on the third set of skills.

9. The computer implemented method of claim 1, wherein the recommending comprises generating a recommendation report based on the one or more jobs and the one or more training programs.

10. The computer implemented method of claim 9 further comprising receiving a feedback on the recommendation report.

11. A system for recommending one or more training programs to a user, the system comprising:
a skill extraction module configured for:
determining a first set of skills associated with a user profile;
determining a second set of skills associated with one or more jobs, wherein the one or more jobs are determined based at least in part on the first set of skills; and
a comparison module configured for comparing the first set of skills and the second set of skills to determine a third set of skills, wherein the third set of skills is not present in the first set of skills;
a training query engine configured for identifying the one or more training programs based on the third set of skills.

12. The system of claim 11, wherein the user profile comprises at least one of personal information, one or more skills, educational details, employment history of the user.

13. The system of claim 11, wherein the user profile further comprises a first set of preferences comprising at least one of one or more preferred locations, hobbies, or one or more desired employers of the user.

14. The system of claim 11 further comprising a survey module configured for presenting a survey to the user to collect a second set of preferences, wherein the second set of preferences comprises at least one of the user's availability for training, one or more preferred locations, one or more desired employers of the user, and a frequency of receiving recommendations.

15. The system of claim 11 further comprising a job listing query engine configured for determining the one or more jobs from at least one of one or more job listing providers or a local repository of jobs based on the user profile.

16. The system of claim 11, wherein the training query engine is configured for identifying the one or more training programs from one or more training providers.

17. The system of claim 11 further comprising a recommendation module for creating a recommendation report based on at least one of the one or more training programs and the third set of skills.

18. The system of claim 17, wherein the recommendation module is further configured for customizing the recommendation report based on one or more user inputs.

19. The system of claim 11 further comprising an e-commerce module configured for generating billing information based on at least one of the one or more jobs or the one or more training programs.

20. A computer program product for use with a computer, the computer program product comprising a computer-usable data carrier storing a computer readable program code embodied therein for recommending one or more training programs to a user, the computer readable program code comprising:
program instruction means for determining a gap between a first set of skills and a second set of skills, the first set of skills is determinable from a user profile and the second set of skills is determinable from one or more jobs identified based on the user profile and the first set of skills, wherein the gap represents a third set of skills present in the second set of skills but not present in the first set of skills; and
program instruction means for identifying the one or more training programs based on the third set of skills.
